(19) United States
(12) Patent Application Publication
(10) Pub. No.: US 2007/0016584 A1
(43) Pub. Date: Jan. 18, 2007

(54) Group access without using an administrator

(76) Inventor: Mathew L. Grell, Norcross, GA (US)

Correspondence Address: Mathew L. Grell, 4307 Jones Bridge Circle, Norcross, GA, 30092, US

(21) Appl. No.: 11/182,560

(22) Filed: Jul. 15, 2005

(51) Int. Cl. G06F 17/30

(52) U.S. Cl. 707/9

(57) ABSTRACT

A system and technique for accessing, joining, creating, storing, publishing, sharing, streaming audio and viewing information between members of a group and/or service provider information by providing access to the group and/or information without the requirement of an administrator, administrative oversight, or a procedural requirement of an invitation and affirmation system.

### TECHNICAL FIELD

The present version of the invention relates generally to transferring data between user and a communication system and more specifically to sharing service provider information among members of a group without the need for a group administrator.

### BACKGROUND

Local service providers focus their advertising dollars on yellow page listings as their primary form of advertising, both in print and online, to distribute contact, goods and/or services information to customers seeking said goods and/or services. Examples of these are the regional Bell operating companies' yellow pages and websites, such as www.realpages.com www.yellowpages.com www.superpages.com and http://yp.yahoo.com. These sites do not focus on helping the consumer make an informed decision when selecting a service provider, but rather their focus is distributing the service provider's contact information and description of goods and/or services.

Currently, consumers have limited means available for quickly finding reputable and qualified service providers in their local area such as dry-cleaning, car repair, dentists, home improvement companies, auto mechanics, etc. Most consumers rely on the above yellow pages and or word-of-mouth referrals from their friends, family, or coworkers to find local service providers. The problem with this is that the referral is based on a very limited sample of service providers and/or the referral is likely based on a single evaluation of this service provider's performance.

There are local search websites where consumers can rate and review local service providers, and where consumers have access to the contact information of such service providers. This information assists the consumer when making a decision to engage the services or purchase the goods of such a provider. Such websites allow a member to invite friends and monitor the reviews of friends, but these websites fail to allow the formation of groups of members.

In addition, other websites exists that have friend and/or group invitation systems and techniques for inviting users by emailing prospective users an email with one or more hyperlinks that upon clicking the hyperlink the website is opened and the user gains access to the website being promoted in the email. Once inside the website a user may view and/or register as a member of the website.

A group within a local search website would allow consumers who share similar interests, needs, associations and/or other factors to form a group separate from the entire body of consumers and together collect and publish information relevant to the group. As set forth above, group membership exists on the Internet but such groups require an administrator as well as a procedural invitation and affirmation system by the administrator to join the group or publish information to the group. Use of such administrators and/or procedures is time consuming and costly to maintain.

Therefore, for the foregoing reasons, it is readily apparent that there is a need for a method and apparatus for joining, creating, storing, publishing, sharing, streaming audio and viewing group information between members of a group or users by providing access to the group information without the requirement of an administrator, administrative oversight, or a procedural requirement of an invitation and affirmation system to join the group.

### BRIEF SUMMARY

Briefly described, in a preferred embodiment, the present version of the invention overcomes the above-mentioned disadvantage, and meets the recognized need for such a device by providing a method and apparatus for joining, creating, storing, publishing, sharing, transmitting, streaming audio and/or viewing information between members of a group or users by providing access to the group and/or its information without the requirement of an administrator, administrative oversight, or a procedural requirement of an invitation and affirmation system.

According to its major aspects and broadly stated, the present version of the invention in its preferred form is a method and apparatus for joining, creating, storing, publishing, sharing, transmitting, streaming audio and/or viewing group information.

More specifically, the present version of the invention is a communication system that shares information, including contact information, ratings, reviews, recommendations and other information relating to service providers with members or users of a group.

Accordingly, a feature and advantage of the present version of the invention is its ability to allow a user or member to create a group where users or members can create, store, publish, view, transmit and/or share information on service providers.

Another feature and advantage of the present version of the invention is its ability to allow a user or member to join a group where users or members can create, store, publish, view, transmit and/or share information on service providers.

Still another feature and advantage of the present invention is its ability to allow a user or member to view group information where users or members can create, store, publish, view, transmit and/or share information on service providers.

Yet another feature and advantage of the present invention is its ability to allow a user or member to create, store, publish, view, transmit and/or share information on service providers without using a group administrator.

Yet another feature and advantage of the present version of the invention is its ability to allow a user or member to create, store, publish, view, transmit and/or share information on service providers with the group without a procedural requirement of an invitation and/or affirmation system to join the group.

Still yet another feature and advantage of the present version of the invention is its ability to allow a user or member to create a group that has a key where users or members with a matching key can create, store, publish, view, transmit and/or share information with the group.

Still yet another feature and advantage of the present version of the invention is its ability to allow a user or member to join a group that has a key where users or members with a matching key gain access to the group.

Still yet another feature and advantage of the present version of the invention is its ability to allow a user or member to view a group that has a key where users or members with a matching key can create, store, publish, view, transmit and/or share information on service providers.

Still yet another feature and advantage of the present version of the invention is its ability to allow a user or member to view a group that has a key where users or members with a non-matching key can view information on service providers.

More specifically, the key can be a geographical region, state, county, city, phone number, zip code, zip code plus extension, school, home owners association, swim tennis community, parent teacher association, sports team, club, religious organization or other association.

Yet another feature and advantage of the present version of the invention is its ability to allow a user or member with a matching key to create, store, publish, view, transmit and/or share information with the group without the requirement of an administrator to join the group.

Yet another feature and advantage of the present version of the invention is its ability to allow a user or member with a matching key to create, store, publish, view, transmit and/or share information with the group without a procedural requirement of an invitation and/or affirmation system to join the group.

Yet another feature and advantage of the present version of the invention is its ability to allow a user or member with a matching key to amend service provider information without the requirement of an administrator.

Yet another feature and advantage of the present version of the invention is its ability to allow a user or member with a matching key to amend service provider information without a procedural requirement of an invitation and/or affirmation system.

These and other features and advantages of the present version of the invention will become more apparent to one skilled in the art from the following description and claims when read in light of the accompanying drawings.

### BRIEF DESCRIPTION OF THE DRAWINGS

The present version of the invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system.

FIG. 2 is a block diagram of a communications system implemented by the system in FIG. 1.

FIG. 3 is a flow diagram of a communication method implemented by the system in FIG. 2.

FIG. 4 is a flow diagram of a communication method, according to the preferred embodiment of the present version of the invention, implemented by the system in FIG. 2.

FIG. 5 is a flow diagram of a communication method, according to the preferred embodiment of the present version of the invention, implemented by the system in FIG. 2.

FIG. 6 is a flow diagram of a communication method, according to the preferred embodiment of the present version of the invention, implemented by the system in FIG. 2.

FIG. 7 is screen shot of a user interface of the method of FIG. 6.

FIG. 8 is screen shot of a user interface of the method of FIG. 6.

FIG. 9 is a flow diagram of a communication method, according to the preferred embodiment of the present version of the invention, implemented by the system in FIG. 2.

FIG. 10 is screen shot of a user interface of the method of FIG. 9.

FIG. 11 is a flow diagram of a communication method, according to an alternate embodiment of the present version of the invention, implemented by the system in FIG. 2.

FIG. 12 is screen shot of a user interface of the method of FIG. 11.

FIG. 13 is screen shot of a user interface of the method of FIG. 11.

FIG. 14 is screen shot of a user interface of the method of FIG. 11.

### DETAILED DESCRIPTION OF THE PREFERRED AND ALTERNATIVE EMBODIMENTS

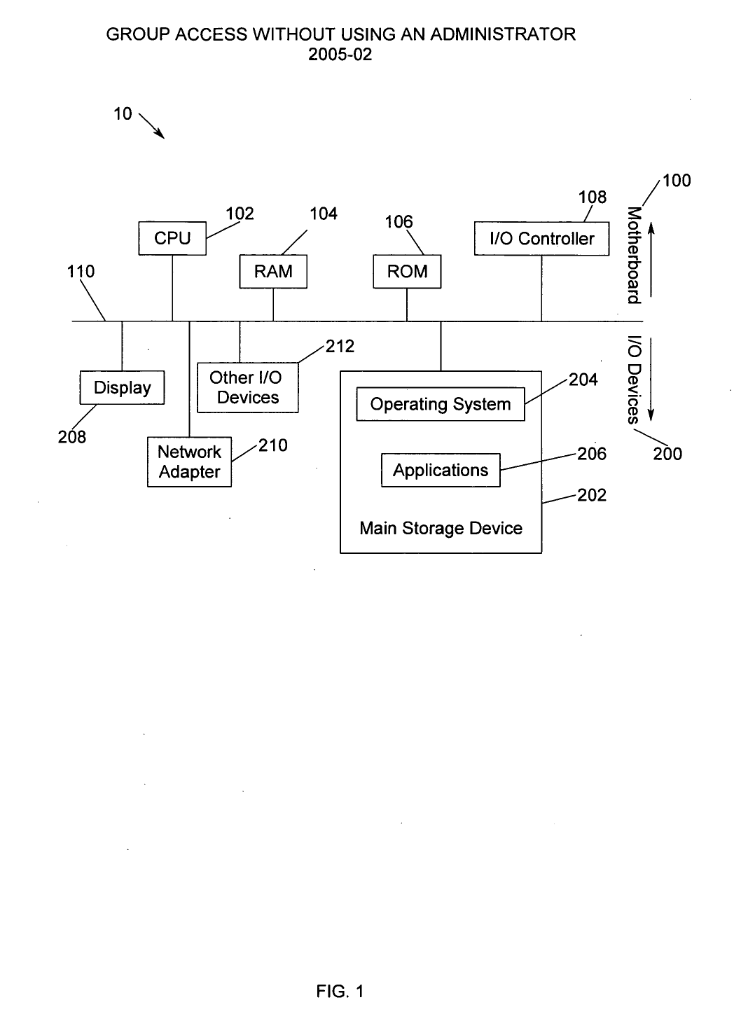

In describing the preferred and alternate embodiments of the present version of the invention, as illustrated in FIGS. 1-14, specific terminology is employed for the sake of clarity. The present version of the invention, however, is not intended to be limited to the specific terminology so selected, and it is to be understood that each specific element includes all technical equivalents that operate in a similar manner to accomplish similar functions.

As will be appreciated by one of skill in the art, the present version of the invention may be embodied as a method, data processing system, or computer program product. Accordingly, the present version of the invention may take the form of an entirely hardware embodiment, entirely software embodiment or an embodiment combining software and hardware aspects. Furthermore, the present version of the invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present version of the invention is described below with reference to flowchart illustrations of methods, apparatus (systems) and computer program products according to embodiments of the present version of the invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It will also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer program for implementing the present version of the invention may be written in various object-oriented programming languages, such as conventional C calling. However, it is understood that other source or object oriented programming languages, and other conventional programming languages could be utilized without departing from the spirit and intent of the present version of the invention.

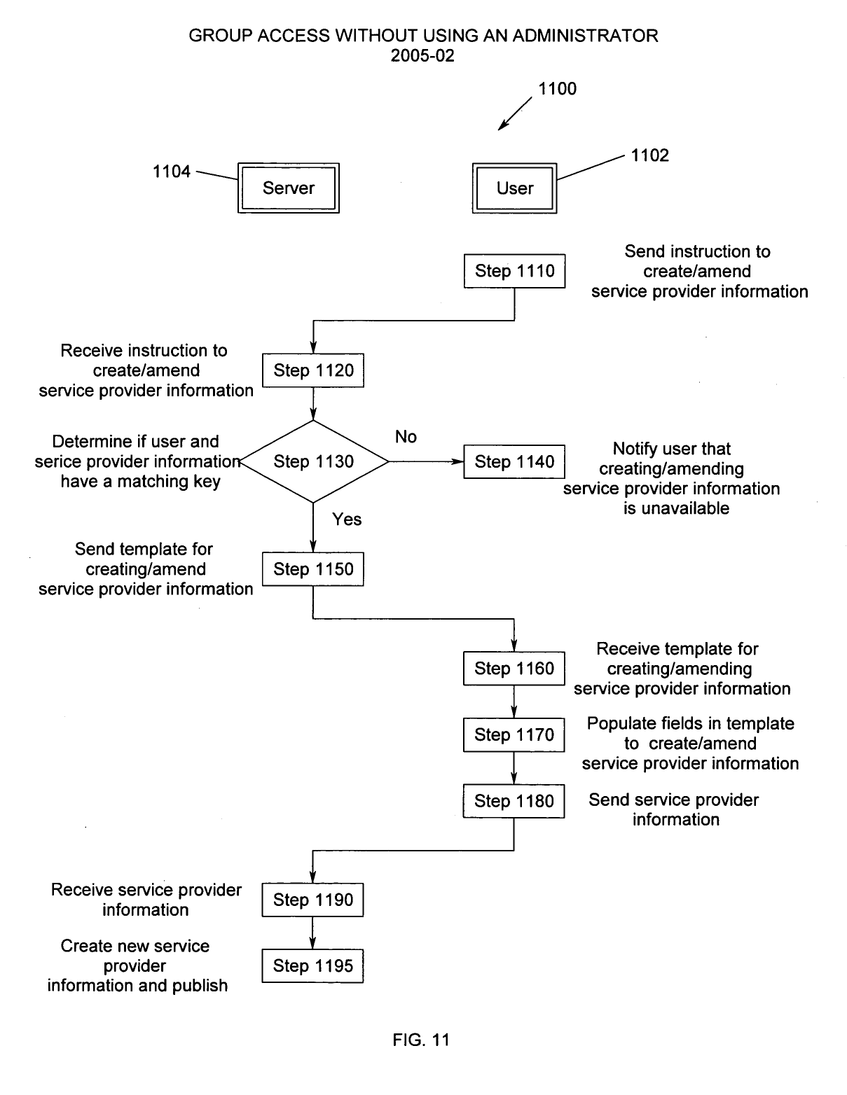

Referring now to FIG. 1-10, the present version of the invention in its preferred embodiment is a method and apparatus for joining, creating, storing, publishing, sharing, transmitting, streaming audio and viewing information between members of a group or users by providing access to the group and/or its information without the requirement of an administrator, administrative oversight, or a procedural requirement of an invitation and affirmation system. Alternate methodologies and apparatus, as shown in FIGS. 11-14, are also intended as embodiments of the present version of the invention, in addition to those preferred will be further discussed herein. For illustrative purposes, FIGS. 1-14 describe a communications system for implementing techniques for creating, transmitting, storing, sharing, viewing and/or publishing electronic information. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present version of the invention. The computer architecture shown in FIG. 1 is divided into two parts the motherboard 100 and the input/output (I/O) devices 200. The motherboard 100 includes a bus 110 which interconnects major subsystems such as a central processor (CPU) 102, a random access memory (RAM) 104, an input/output (I/O) controller 108, and read-only memory (ROM) 106, also known as firmware. A basic input output system (BIOS) containing the basic routines that help to transfer information between elements within the computer is stored in the ROM 106 or operably disposed in RAM 104. The computer further includes I/O devices such as a main storage device 202 for storing an operating system 204 and application programs 206 and a display 208 for visual output, respectively. The main storage device 202 is connected to the CPU 102 through a main storage controller (not shown) connected to bus 110. Network adapter 210 allows the computer system to send and receive data through communication devices. One example of a communications device is a modem. Other examples include a transceiver, a set-top box, a communication card, a satellite dish, an antenna, or another network adapter capable of transmitting and receiving data over a communications link that is either a wired, optical, or wireless data pathway.

Many other devices or subsystems 212 (not shown) may be connected in a similar manner such as without limitation a keyboard and a pointing device (e.g., a mouse), a floppy disk drive operative to receive a floppy disk, and a CD-ROM player operative to receive a CD-ROM, a printer and a modem each connected via an I/O adapter. Also, it is not necessary for all of the devices shown in FIG. 1 to be present to practice the present version of the invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion.

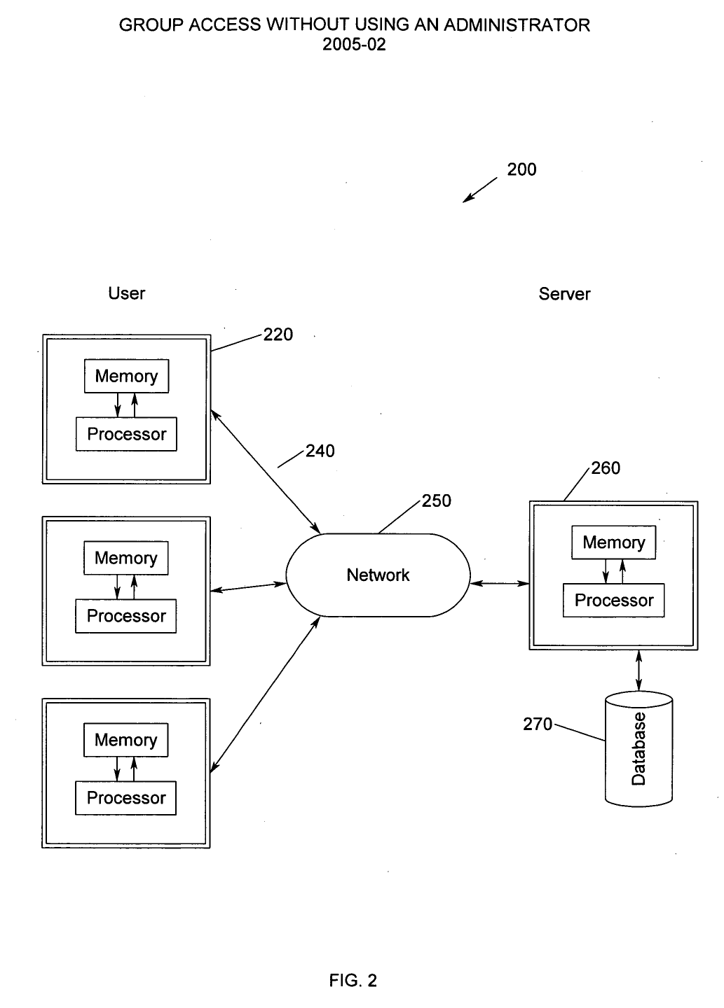

Referring now to FIG. 2, there is illustrated a diagram depicting an exemplary system in which concepts consistent with the present version of the invention may be implemented. Examples of each element within the communication system of FIG. 2 are broadly described above with respect to FIG. 1. In particular, the server system 260 and user system 220 have attributes similar to computer system 10 of FIG. 1 and illustrates one possible implementation of that system. The communication system 200 includes one or more user system 220, and one or more server device 260, and a network 250, which could be, for example, the Internet. User systems 220 each include a computer-readable medium, such as random access memory, coupled to a processor. The processor executes program instructions stored in memory. User system 220 may also include a number of additional external or internal devices, such as, without limitation, a mouse, a CD-ROM, a keyboard, a display, a storage device and other attributes similar to computer system 10 of FIG. 1. The communications system 200 typically includes one or more user system 220. For example, the user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains an application program and other applications 280 (not shown). For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communication links 240 and/or network 250. Through user system 220, users can communicate over network 250 with each other and with other systems and devices coupled to network 250, such as server system 260. The communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link 240 may include, for example, a wired, wireless, cable, optical or satellite communication system or pathway.

Application program 280 includes search engine 282 (not shown), which locates relevant information in response to search queries from user system 220. In particular, a user operating user system 220 sends search queries to server system 260, which server system 260 and its application programs responds to by returning a list of relevant information to the user at user system 220. Typically, a user system 220 asks server system 260 to locate information relating to a particular key word, topic, area or category. In a preferred embodiment of the present version of the invention search engine 282 searches a set of service provider data and/or information stored in database 270 and responds to the user's query by returning a list of relevant data and/or information to the user at user system 220 matching user's search query. The user may request server system 260 and/or user system 220 to re-order the service provider data and/or information matching user's query based on distance, proximity, coupon, rating, review, and/or recommendation or other such information as would meet the purpose described herein. Application program 280 locates service providers from a body of service provider records stored in database 270 by comparing the terms in the user's search query to the service providers records in database 270. In general, processes for indexing records and searching the indexed body of records to return a set of records containing the searched terms are well known in the art.

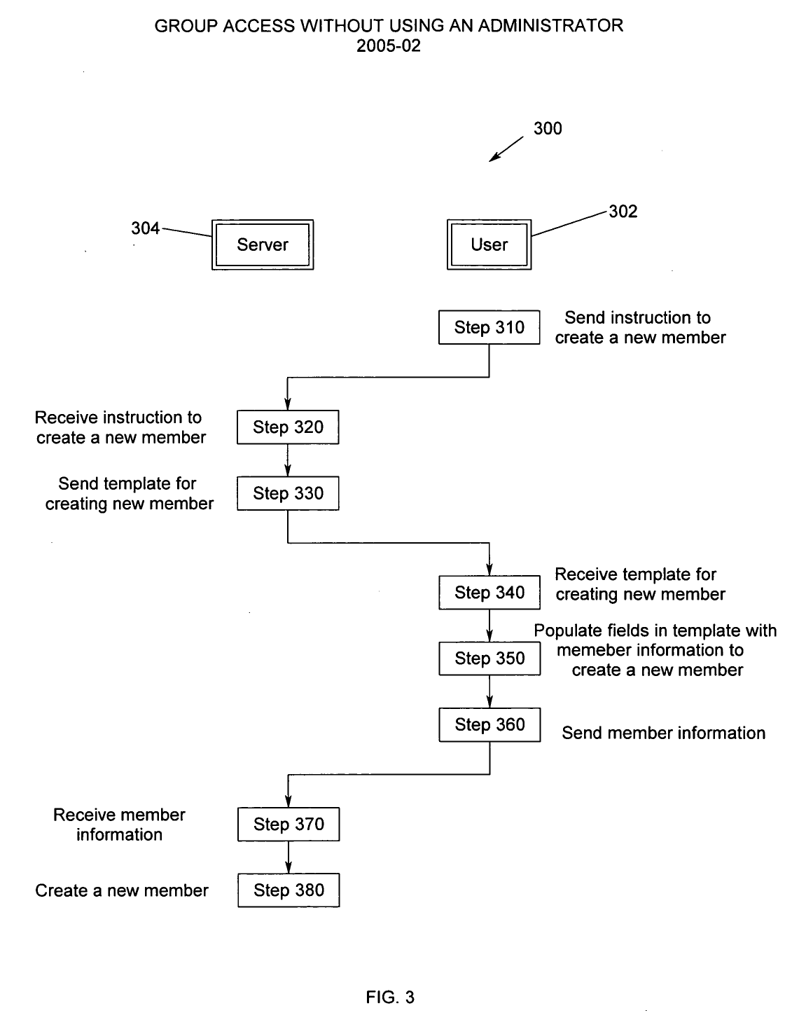

Referring now to FIG. 3, there is illustrated a preferred flow diagram in which user 302 and server 304 interact according to a process 300 within the communication system 200 of FIG. 2. User 302 preferably has attributes comparable to those described above with respect to user system 220. User is referred to hereafter as a user of communication system 200 and/or member based on the methods described herein. Server 304 preferably has attributes comparable to those described above with respect to server system 260. Server 304 is preferably interconnected to user 302 through a known or described delivery network. The network preferably has attributes comparable to those described above with respect to network 250. Procedure 300 preferably can be implemented by communication system 200 or other similar hardware, software, device, computer, computer system, equipment, component, application, code, storage medium, or propagated signal.

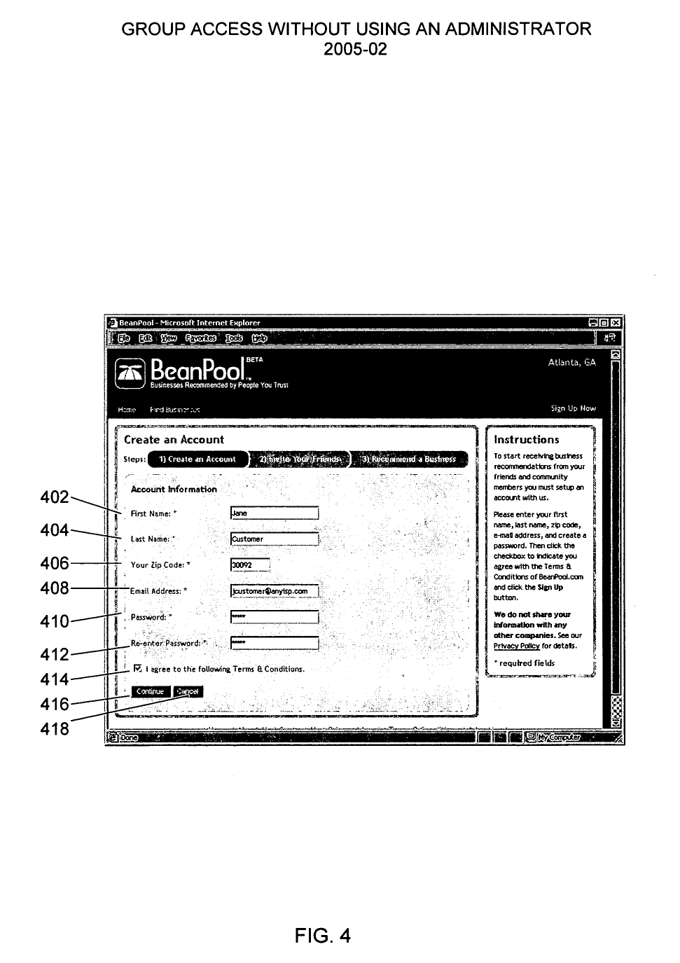

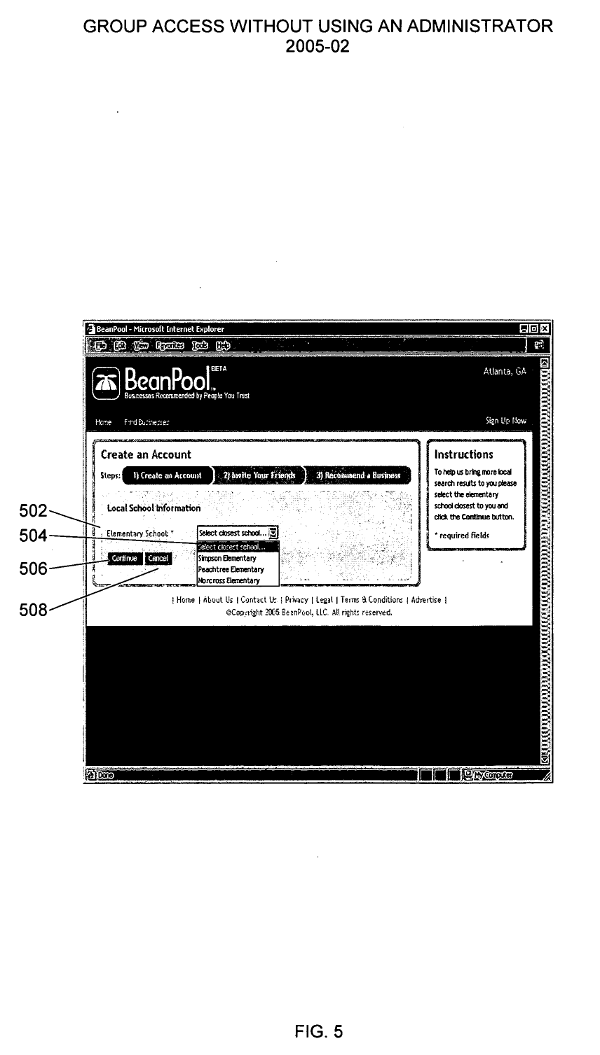

As illustrated in FIG. 3, user 302 preferably sends to server 304 an instruction to become a member and/or create a member profile (step 310). Server 304 preferably receives the instruction that user 302 has requested to become a member and/or create a member profile (step 320). In response server 304 preferably sends user 302 at least one template 400 for user 302 to fill in and/or populate with member information (step 330). User 302 preferably receives at least one template 400 (shown in FIGS. 4 and 5) from server 304 (step 340). Template 400 preferably is a graphical user interface having at least one field or window that enables user to enter text and/or data in predefined fields. User 302 preferably enters text and/or data into template 400 populating the fields of template 400 with member information (step 350).

Referring now to FIG. 4, there is illustrated a preferred screen shot of a user interface disclosing a template to enter member information, including user's first name 402, last name 404, zip code (may include zip code extension) 406, email address 408, password 410, re-enter password 412, a check box (agreeing to the terms and conditions) 414, continue button 416, and cancel button 418 or other such user information as would meet the purpose described herein.

Referring now to FIG. 5, there is illustrated a preferred screen shot of a user interface disclosing a template to enter a member key, including a drop down window selection box preferably populated with local elementary schools 502, drop down window 504, continue button 506, and cancel button 508 or other such user information as would meet the purpose described herein. User 302 preferably selects the elementary school where user 302 is domiciled or has a principle place of residence. Member key such as elementary school 502 is preferably where user resides, however, member key may include other geographical regions, including, but is not limited to, middle or high school district, phone number, zip code, zip code plus extension, GPS, radius from a central point, city, county, state or province, country or other such information as would meet the purpose described herein (referred to hereinafter as “Member Key”).

User 302 clicks on the continue button of template 400 and sends user's member information to server 304 (step 360). Server 304 receives the user's member information (step 370) and creates a member profile and/or record using user's member information (step 380). Server 304 determines whether or not a member with such member information already exists and if so sends a message to user 302 stating that a member with such member information already exists.

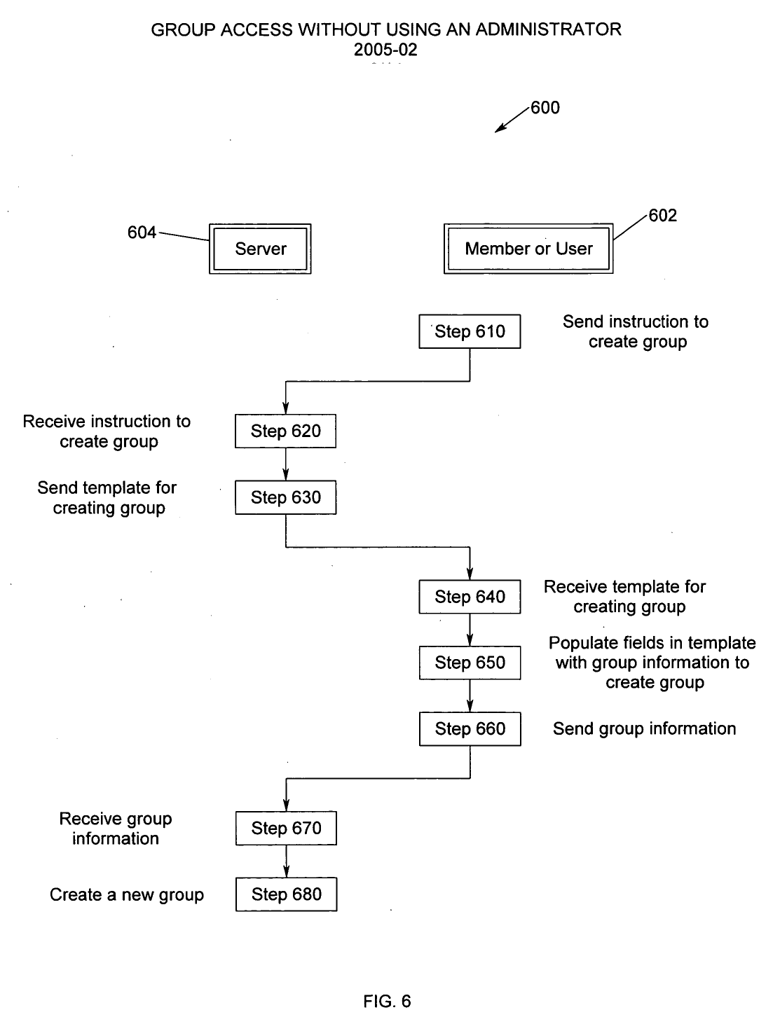

Referring now to FIG. 6, there is illustrated a preferred flow diagram in which user 602 and server 604 interact according to a process 600 within the communication system 200 of FIG. 2. User 602 preferably has attributes comparable to those described above with respect to user system 220. Server 604 preferably has attributes comparable to those described above with respect to server system 260. Server 604 is preferably interconnected to user 602 through a known or described delivery network. The network preferably has attributes comparable to those described above with respect to network 250. Procedure 600 preferably can be implemented by communication system 200 or other similar hardware, software, device, computer, computer system, equipment, component, application, code, storage medium, or propagated signal.

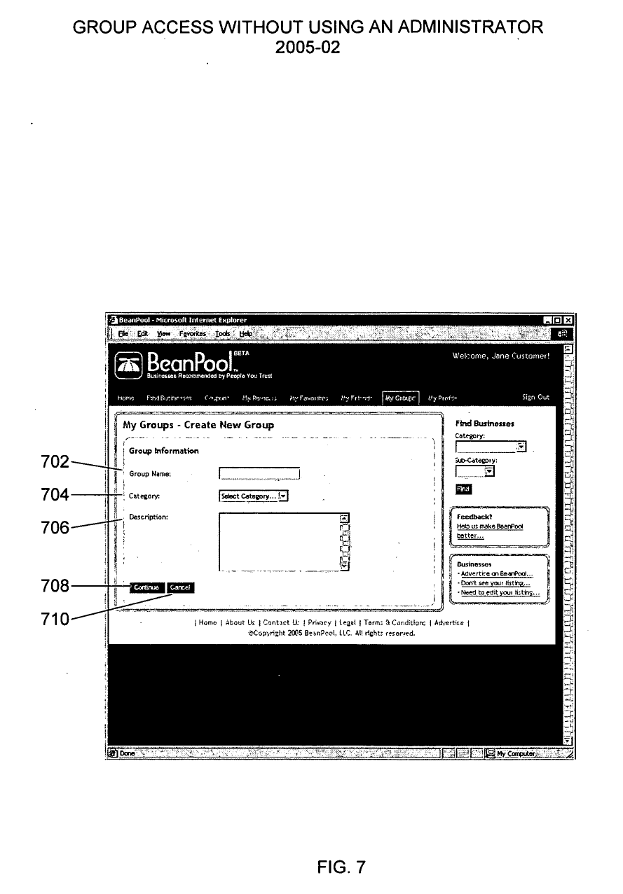

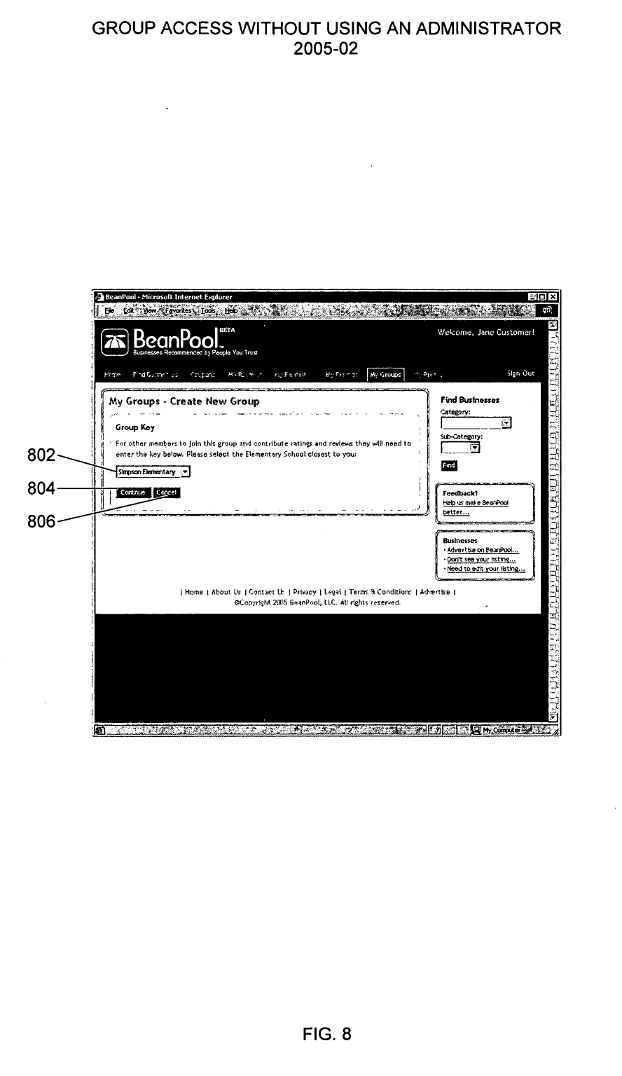

As illustrated in FIG. 6, user 602 preferably sends to server 604 an instruction to create a group and/or create a group profile (step 610). Server 604 preferably receives the instruction that user 602 requested to create a group and/or create a group profile (step 620). In response server 604 preferably sends user 602 at least one template 700 for user 602 to fill in and/or populate with group information (step 630). User 602 preferably receives at least one template 600 (shown in FIGS. 7 and 8) from server 604 (step 640). Template 700 preferably is a graphical user interface having at least one field or window that enables user 602 to enter text and/or data in predefined fields. User 602 preferably enters text and/or data into template 700 populating the fields of template 700 with group information (step 650).

Group preferably is a collection of users or members with similar interests, needs, associations and/or other factors, including but not limited to home owners association, swim/tennis community, parent teacher association, sports team, club, religious organization or any other such association as would meet the purpose described herein.

Referring now to FIG. 7, there is illustrated a preferred screen shot of a user interface disclosing a template to create a group, including a text entry box for group name 702, a drop down window selection box populated with group category 704, a text entry box for group description 706, continue button 708, and cancel button 710 or other such group information as would meet the purpose described herein.

Referring now to FIG. 8, there is illustrated a preferred screen shot of a user interface disclosing a template to enter a group key, including a drop down window selection box preferably populated with local elementary schools 802 a continue button 804, and cancel button 806 or other such group information as would meet the purpose described herein. User 602 preferably selects the elementary school where the group is resides or has a principle place of business. Group key such as elementary school 802 is preferably where group resides, however, group key may be other geographical regions, including, but is not limited to, middle or high school district, phone number, zip code, zip code plus extension, GPS, radius from a central point, city, county, state or province, country or other such information as would meet the purpose described hereinafter (referred to herein as “Group Key”).

User 602 clicks on the continue button of template 700 and sends group information to server 604 (step 660). Server 604 receives the group information (step 670) and creates a group profile and/or record using the group information (step 680). Server 604 determines whether or not a group with such group information already exists and if so sends a message to user 602 stating that a group with such group information already exists.

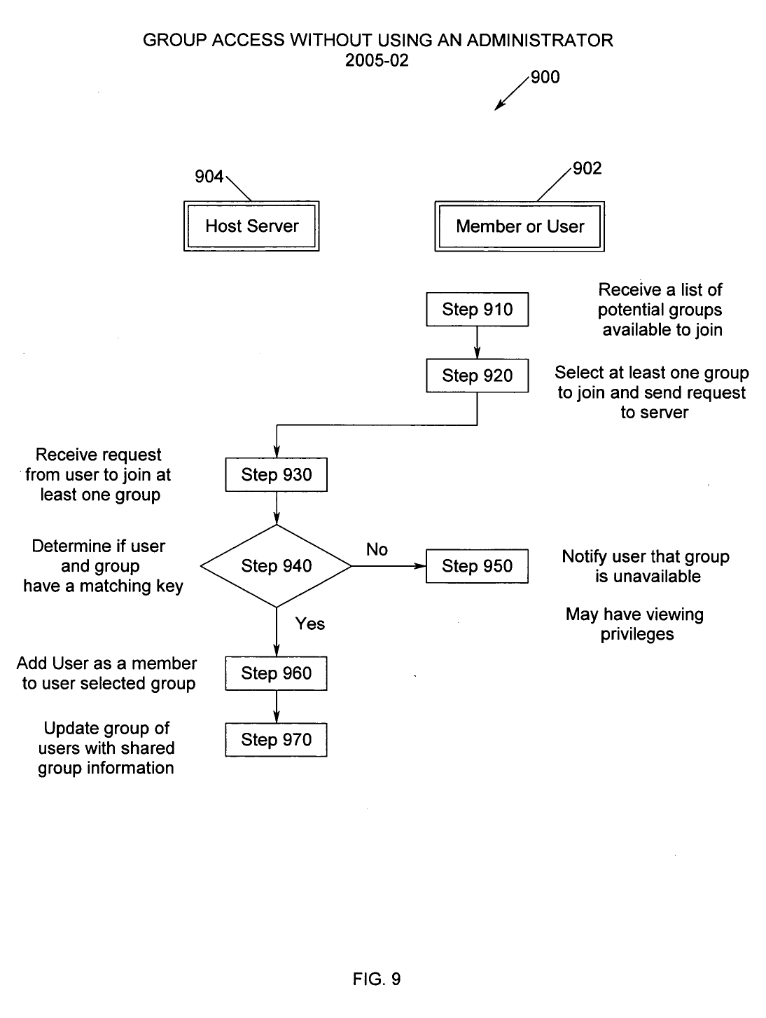

Referring now to FIG. 9, there is illustrated a preferred flow diagram in which user 902 and server 904 interact according to a process 900 within the communication system 200 of FIG. 2. User 902 preferably has attributes comparable to those described above with respect to user system 220. Server 904 preferably has attributes comparable to those described above with respect to server system 260. Server 904 is preferably interconnected to user 902 through a known or described delivery network. The network preferably has attributes comparable to those described above with respect to network 250. Procedure 900 preferably can be implemented by communication system 200 or other similar hardware, software, device, computer, computer system, equipment, component, application, code, storage medium, or propagated signal.

As illustrated in FIG. 9, user 902 preferably sends to server 904 an instruction to receive a list of potential groups available to user 902. Server 904 preferably receives the instruction that user 902 requested to receive a list of potential groups. In response server 904 preferably sends user 902 at least one template 1000 for user 902 to select a group to join. User 902 preferably receives template 1000 from server 904 (step 910). User 902 preferably selects at least one group from the list of groups available to user 902 and sends such request to server 904 (step 920). Template 1000 preferably is a graphical user interface having at least one field or window that enables user to enter text and/or data in predefined fields. User 902 preferably enters text and/or data into template 1000 populating the fields of template 1000 with group selection information (step 920).

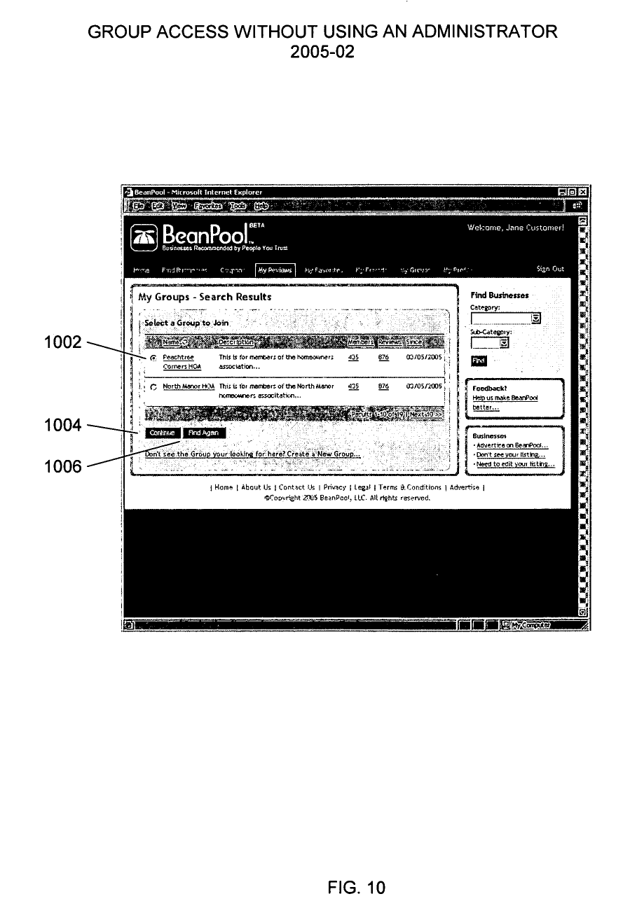

Referring now to FIG. 10, there is illustrated a preferred screen shot of a user interface disclosing a template where user 902 can select a group to join from a list of potentially available groups to join by user 902. User 902 can select a group by clicking the circle 1002 in front of the group name or by any other selection system that would meet the purpose defined herein. User 902 preferably selects the group user 902 desires to join/contribute and clicks the continue button 1004 to send the selection to server 904 or clicks the cancel button 1006 to cancel the selection.

Server 904 preferably receives the instruction that user 902 requested to join/contribute the selected group (step 930). In response server 904 preferably determines whether user 902 and selected group have a matching Member Key and Group Key (step 940). If user 902 and selected group have a matching key, server 904 adds user 902 to the selected group's authorized list of users (step 960). Upon authorization, user 904 preferably can view ratings, reviews, and recommendations made by others authorized users of the group, as well as having the ability to identify, create, store, transmit, share and/or publish user's 904 own information, such as ratings, reviews, and/or recommendations within the group or any other information that would meet the purpose defined herein. Otherwise, server 904 sends user 902 a notice that the selected group is not available as a group for user 904 to join/contribute (step 950). Server 904 updates selected group with user 904 and transmits group information to all authorized users (step 970).

The purpose of the key system is to preferably limit users and/or members who have full access to the group and in particular to those who can publish information within the group, thus, maintaining and/or preserving the relevance of the shared information to that of the authorized users of the group. Other non-group members may or may not be able to view the group's information. The key may or may not be invoked depending on the originator of the group. The key may or may not be used to limit users or members who are authorized to identify, create, store, transmit, share and/or publish information within the group.

Referring now to FIG. 11, there is illustrated an alternate flow diagram in which user 1102 and server 1104 interact according to a process 1100 within the communication system 200 of FIG. 2. User 1102 preferably has attributes comparable to those described above with respect to user system 220. Server 1104 preferably has attributes comparable to those described above with respect to server system 260. Server 1104 is preferably interconnected to user 1102 through a known or described delivery network. The network preferably has attributes comparable to those described above with respect to network 250. Procedure 1100 preferably can be implemented by communication system 200 or other similar hardware, software, device, computer, computer system, equipment, component, application, code, storage medium, or propagated signal.

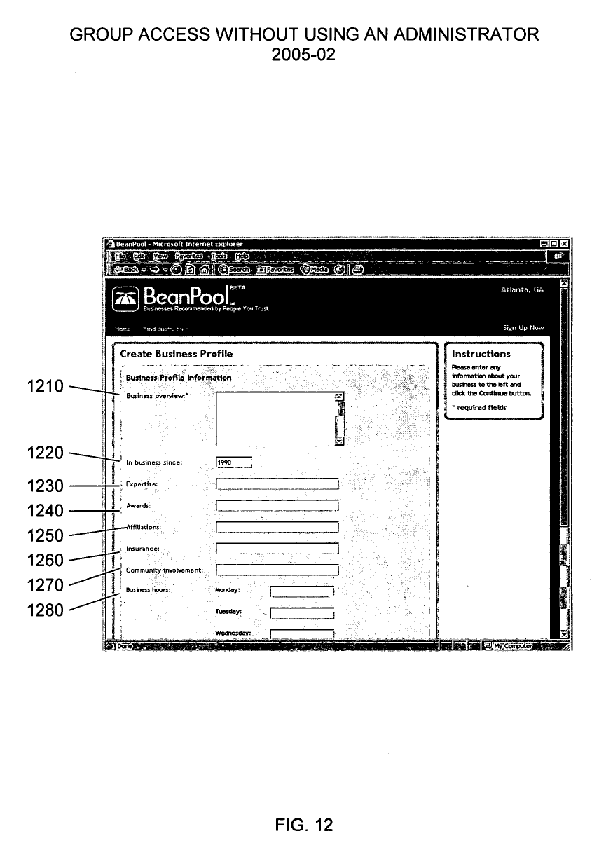

As illustrated in FIG. 11, user 1102 preferably sends to server 1104 an instruction to create/amend service provider information (step 1110). Server 1104 preferably receives the instruction that user 1102 requested to create/amend service provider information (step 1120). In response server 1104 preferably determines whether user 1102 and selected service provider information have a matching Member Key and Service Provider Key (see below) (step 1130). If user 1102 and service provider information have a matching key server 1104 allows user 1102 access to create/amend such service provider information. User's 1104 with access preferably can create/amend service provider information or any other information that would meet the purpose defined herein. Otherwise, server 1104 sends user 1102 a notice that the selected service provider information is not available to user 1104 to amend/create such information (step 1140). Server 1104 preferably sends user 1102 at least one template 1200 for user 1102 to create/amend service provider information (step 1150). User 1102 preferably receives at least one template 1200 (shown in FIGS. 12, 13, and 14) from server 1104 (step 1160). Template 1200 preferably is a graphical user interface having at least one field or window that enables user to enter text and/or data in predefined fields. User 1102 preferably enters text, pictures, audio, movies and/or other data into template 1200 populating the fields of template 1200 with service provider information (step 1170).

Referring now to FIG. 12, there is illustrated a preferred screen shot of a user interface disclosing a template to create/amend service provider information. Service provider information such as service provider name, address, and phone number preferably exist as a record within server 1104, however, if not already a record then text entry boxes for service provider name, address, and phone number (not shown) can be added to FIG. 12. In addition, FIG. 12 discloses a text entry box for service provider's description or business overview 1210, a text entry box for service provider's date of the start of its business 1220, a text entry box for service provider's area of expertise 1230, a text entry box for service provider's awards 1240, a text entry box for service provider's affiliations 1250, a text entry box for service provider's insurance 1260, a text entry box for service provider's community involvement 1270, a text entry box for service provider's hours of operation 1280, a drop down window selection box preferably populated with business phone number used as service provider key (not shown) as well as text boxes and/or browse window for adding pricing, URL, terms and conditions, warranty, license, certification, testimonials (contact information for those providing testimonies), quotes, pictures, audio, video, continue button, and cancel button (not shown), or other such service provider information as would meet the purpose described herein. By clicking the continue button (not shown) the service provider information will be sent to server 1104.

Service provider key is preferably business telephone number, however, group key may be other service provider information including, but is not limited to, elementary, middle or high school district, phone number, zip code, zip code plus extension, GPS, radius from a central point, city, county, state or province, country or other such information as would meet the purpose described hereinafter (referred to herein as “Service Provider Key”).

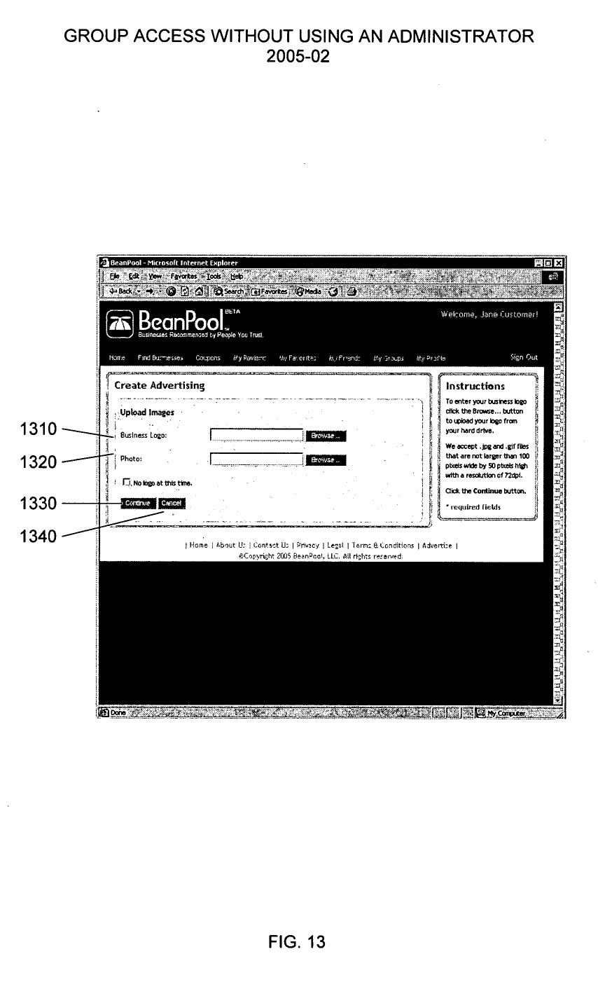

Referring now to FIG. 13, there is illustrated a preferred screen shot of a user interface disclosing a browse window to locate and add business logo 1310, a browse window to locate and add picture(s) 1320 depicting service(s) performed by service provider, continue button 1330, and cancel button 1340, including but not limited to tag line, audio, video or other such service provider information as would meet the purpose described herein.

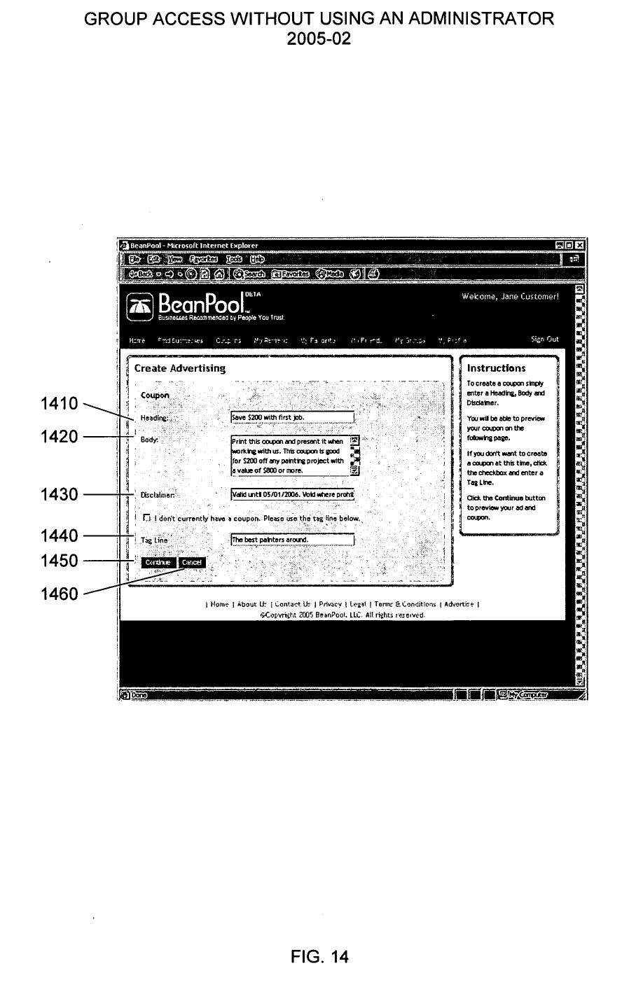

Referring now to FIG. 14, there is illustrated a preferred screen shot of a template to create/amend a service provider coupon, including a heading 1410, body 1420, disclaimer 1430, tag line 1440, continue button 1450, and cancel button 1460, including but not limited to percentage discount, dollar value reduction, reference code, free estimates, consultation, analysis, trademark, service mark, trade name, logo, terms and conditions, URL, expiration, or other such service provider information as would meet the purpose described herein.

User 1102 clicks on the continue button of template 1200 and sends user's service provider information to server 1104 (step 1180). Server 1104 receives the user's service provider information (step 1190) and creates/amends service provider's information, profile, and/or record using user's service provider information (step 1195).

Having thus described exemplary embodiments of the present version of the invention, it should be noted by those skilled in the art that the within disclosures are exemplary only, and that various other alternatives, adaptations, and modifications may be made within the scope of the present version of the invention. Accordingly, the present version of the invention is not limited to the specific embodiments illustrated herein, but is limited only by the following claims.

What is claimed is:

1. A computer implemented method for facilitating group access, the method comprising:
receiving instructions from at least one user requesting access to at least one group;
determining whether said user and said group have a matching key; and
granting access to said user with said matching key to said group.

2. The computer implemented method of claim 1, further comprising sending a list of groups available to said user to join.

3. The computer implemented method of claim 1, further comprising selecting at least one group to join.

4. The computer implemented method of claim 1, further comprising sending instructions from at least one user requesting access to at least one group.

5. The computer implemented method of claim 1, further comprises denying access to said user with a non matching key.

6. The computer implemented method of claim 1, further comprises granting group publication rights to said user with said matching key.

7. The computer implemented method of claim 1, further comprises adding user with said matching key to a group membership.

8. The computer implemented method of claim 1, further comprises updating group membership with group information.

9. The computer implemented method of claim 1, further comprises creating a group key.

10. The computer implemented method of claim 1, further comprises creating a member key.

11. The computer implemented method of claim 1, further comprises creating a user record based upon information entered by said user.

12. The computer implemented method of claim 1, further comprises amending a user record based upon information entered by said user.

13. The computer implemented method of claim 1, further comprises creating a group record based upon information entered by said user.

14. The computer implemented method of claim 1, further comprises amending a group record based upon information entered by said user.

15. A computer implemented method for facilitating service provider record access, the method comprising:
receiving instructions from at least one user requesting access to at least one service provider record;
determining whether said user and said service provider record have a matching key; and
granting access to said user with said matching key to said service provider record.

16. The computer implemented method of claim 15, further comprising sending instructions from at least one user requesting access to at least one service provider record.

17. The computer implemented method of claim 15, further comprises denying access to said user with a non matching key.

18. The computer implemented method of claim 15, further comprises granting publication rights to said user with said matching key.

19. The computer implemented method of claim 15, further comprises creating a service provider record based upon information entered by said user.

20. The computer implemented method of claim 15, further comprises amending a service provider record based upon information entered by said user.

21. The computer implemented method of claim 15, further comprises creating a service provider key.

22. A system comprising:
a server connected to a network, the server receiving requests from users via the network, the server including:
at least one processor;
a database of group records; and
a memory operatively coupled to the processor, the memory storing program instructions that when executed by the processor, cause the processor to: generate a list of groups available to a user, receive a selection by a user to join a group, determine whether said group and said user have a matching key, and grant access to said user with said matching key to said group.

23. A system for facilitating group access comprising:
means for generating a list of groups available to a user;
means for receiving a selection by a user to join a group;
means for determining whether said group and said user have a matching key; and
means for granting access to said user with said matching key to said group.
